(19) United States
(12) Patent Application Publication
(10) Pub. No.: US 2007/0226776 A1
(43) Pub. Date: Sep. 27, 2007

(54) SECURITY MANAGEMENT SYSTEM ACHIEVED BY STORING PRINT LOG AND PRINT DATA

(76) Inventor: Yasuhiko TSUGAWA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/685,290

(22) Filed: Mar. 13, 2007

(30) Foreign Application Priority Data
Mar. 24, 2006 (JP) 2006-084236

(51) Int. Cl. H04L 9/00

(52) U.S. Cl. 726/1

(57) ABSTRACT

A print server receives print data and control data including at least any of a job name, a terminal name and a user name from a client terminal, sends the print data to a printer and causes the printer to print the print data. Whether the print data includes a predetermined keyword is determined, and when included, an e-mail reporting that is sent to a superior of the person who executed printing and an administrator of the system. Further, a time stamp is attached to the control data and accumulated together with the print data as a print log in a log server. The print log accumulated in the log server is searched as necessary and print image data is generated from the print data to enable browsing. This prevents information leakage via printed matters and enables tracking down the cause of leakage when there is information leakage.

### BACKGROUND OF THE INVENTION

1. Field of the Invention

The present invention relates to a management system for a printer, and particularly relates to a security management system which makes it possible to check the contents or the like of printed matters at a later date, by storing print logs and print data.

2. Description of the Related Art

There has been a growing importance of information management in corporate activities. Among the routes through which information is leaked, one is via paper, namely printed matters.

One method for preventing information leakage, for example, is restricting the print function of a specified application program. However, even if printing is restricted for certain applications, it is still possible to print the contents displayed on a screen, if a print screen function (hard-copying of screen) provided by conventional OSes (Operating Systems) is used. On the other hand, it is unrealistic to inhibit all printing. It is unrealistic as well, for the administrators to check in advance all the matters to be printed.

A print system for solving such a problem is disclosed in Unexamined Japanese Patent Application KOKAI Publication No. 2002-149371. In this print system, control data, print data and bit-map data are collected as a print log in a management terminal beforehand. When a problem occurs at a later date, the print system specifies the print data with reference to the control data, prints the print data again or displays the bit map thereof to specify the details of the problem.

However, the system disclosed in this Japanese reference has such a problem that it is difficult to find printed data from the print logs when a problem occurs at a later date.

Particularly it is difficult to specify the printed matter since a problem will occur after some time has passed. Accordingly, it is desired that it becomes possible to specify an illicit, or potentially illicit printing act in real time.

The present invention is made in view of the above, and it is an object of the present invention to provide a system that is capable of preventing the leakage of information occurring via printed matters.

It is another object of the present invention to provide a system by which the cause of the leakage of information can easily be found out when, for example, information is leaked.

It is still another object of the present invention to provide a system that can monitor and detect the occurrence of an act that might cause the leakage of information.

### SUMMARY OF THE INVENTION

To achieve the above objects of the invention, a print log management system according to a first aspect of the present invention is a security management system achieved by storing a print log, comprising a plurality of print request terminals, a management unit and a printer, wherein

each of the plurality of print request terminals includes a unit which sends print data to the management unit, and

the management unit includes:
a reception unit which receives print data sent from the plurality of print request terminals;
a sending unit which sends the print data received by the reception unit to the printer;
a predetermined word detection unit which determines whether or not the print data includes a predetermined word;
an e-mail sending unit which sends, to a previously registered destination, an e-mail that reports that print data including the predetermined word is printed, when the predetermined word detection unit determines that the predetermined word is included in the print data;
an accumulation unit which accumulates a print log including the print data; and
a print log output unit which outputs a print log accumulated in the accumulation unit.

The print log output unit, for example, may include:

a unit which searches through print data accumulated in the accumulation unit, and

a unit which generates a thumbnail image of a print image of each print data, more than one print data match the search condition.

The security management system may further comprise a unit which inhibits the sending unit from sending the print data to said printer when the predetermined word detection unit determines that the predetermined word is included.

To achieve the above object of the invention, a storage medium according to a second aspect of the present invention is a print log management system comprising:

a reception unit which receives print data from a print request terminal;

a sending unit which sends the print data received by the reception unit to a printer;

a predetermined word detection unit which determines whether the print data includes a predetermined word;

an e-mail sending unit which sends, to a previously registered destination, an e-mail that reports that print data including the predetermined word is printed, when the predetermined word detection unit determines that the predetermined word is included in the print data;

an accumulation unit which accumulates a print log including the print data; and

a print log output unit which outputs a print log accumulated in the accumulation unit.

To achieve the above objects, a security management system according to a third aspect of the present invention is a computer-readable storage medium having a print log management program recorded thereon, the print log management program causing a computer to execute the steps of:

receiving print data from a print request terminal;

sending the received print data to a printer;

determining whether the print data includes a predetermined word;

sending, to a previously registered destination, an e-mail that reports print data including the predetermined word is printed, when it is determined that the predetermined word is included,

accumulating a print log including the print data; and

outputting an accumulated print log.

### BRIEF DESCRIPTION OF THE DRAWINGS

These objects and other objects and advantages of the present invention will become more apparent upon reading of the following detailed description and the accompanying drawings in which:

FIG. 1 is a diagram showing the structure of a printing system according to an embodiment of the present invention;

FIG. 2 is a diagram illustrating an example of the configuration of the print server shown in FIG. 1;

FIG. 3 is a diagram illustrating an example of the configuration of a key word table stored in a storage unit of the print server;

FIG. 4 is a diagram illustrating an example of the configuration of an organization information table stored in the storage unit of the print server;

FIG. 5 is a diagram showing an example of the configuration of the log server of FIG. 1;

FIG. 6 is a flowchart for explaining the printing process of the print server;

FIG. 7 is a flowchart for explaining a print log search operation of the print server;

FIG. 8A is a diagram showing one example of print data supplied to the print server from a terminal;

FIG. 8B is diagram showing an example of a print log generated by the print server;

FIG. 9A is a diagram showing an example of a template of an e-mail to be sent to a superior;

FIG. 9B is a diagram showing an example of a template of an e-mail to be sent to an administrator;

FIG. 9C is a diagram showing an example of an e-mail actually to be sent to a superior;

FIG. 9D is a diagram showing an example of an e-mail actually to be sent to an administrator;

FIG. 10 is a diagram showing an example of a search result screen in the case where a plurality of print logs are found;

FIG. 11 is a diagram showing one example of a search result screen in the case where one print log is found, or in the case where one print log is selected from the search result screen of FIG. 10;

FIG. 12 is a diagram showing a modified example of a notification e-mail;

FIG. 13 is a flowchart for explaining a modified example of the printing process of the print server; and

FIGS. 14A and 14B are diagrams showing modified examples of the notification e-mails.

### DETAILED DESCRIPTION OF THE PREFERRED EMBODIMENTS

The following describes a printing system according to an embodiment of the present invention.

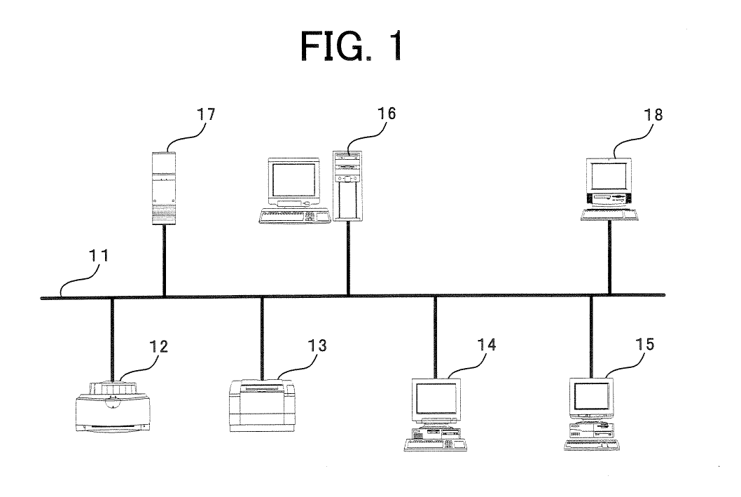

FIG. 1 shows the structure of a printing system according to this embodiment.

As illustrated in the drawing, this printing system comprises printers 12 and 13 that are mutually connected via a network 11, such as a LAN (Local Area Network), an intranet, etc., client terminals 14 and 15, a print server 16, a log server 17 and a management terminal 18.

The printers 12 and 13 are under the management of the print server 16, and individually print images in response to a print command.

The client terminals 14 and 15 individually have a printer driver, and issue a print job (the unit of a task executed in the printers) and print data (text data, etc. and a control command) to the print server 16.

In terms of hardware, the print server 16 is constituted by a common print server. The print server 16 receives print data from the client terminals 14 and 15, by the unit of print job and causes the printers 12 and 13, which are under the control thereof, to print these print data. In addition to this, the print server 16 has a function of obtaining a print log. The print log includes information for specifying a print job. It further includes, year, month, day and time of printing, and print data in RAW format. The RAW format data is a format readable by the printers (the format actually sent to the printers 12 and 13 for printing).

The print server 16 has a function of removing control information from the print data and extracting text data. When the extracted text matches a preset keyword, the print server 16 notifies a previously registered user by sending an e-mail.

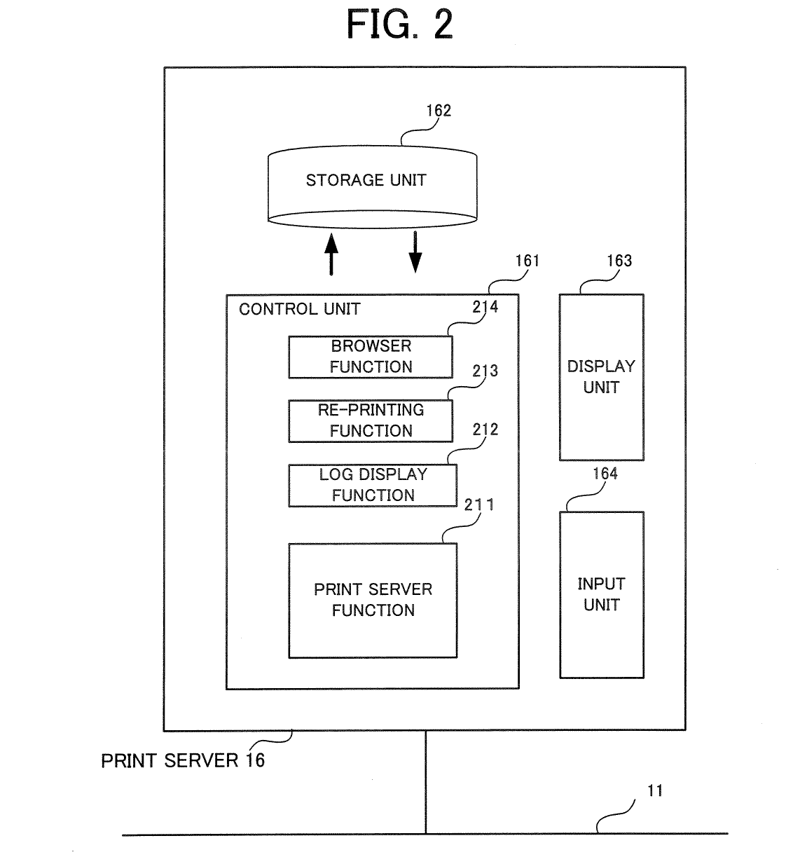

FIG. 2 shows the structure of the print server 16.

As illustrated in the drawing, the print server 16 comprises a control unit 161, a storage unit 162, a display unit 163 and an input unit 164.

The control unit 161 comprises a print server function 211, a log display function 212, a re-printing function 213 and a browser function 214.

The print server function 211 receives print data from the client terminals 14 and 15 by the unit of print job, spools the print data and sends it to the printers 12 and 13.

Further, the print server function 211 copies the print data sent from the client terminals 14 and 15 to a designated directory. Then, the print server function 211 generates a print log by associating print data and control data (job ID, job name (the name of a document), the name of a client terminal, user name, date of reception of a job (year, month, day, hour, minute and second; a time stamp), etc.) with each other. The print server function 211 stores the generated print log to the log server 17.

Further, the print server function 211 extracts text data, which is the contents to be printed, from the print data. The print server function 211 also determines whether the extracted text corresponds to any keyword registered in advance in a key word table T1 stored in the storage unit 162.

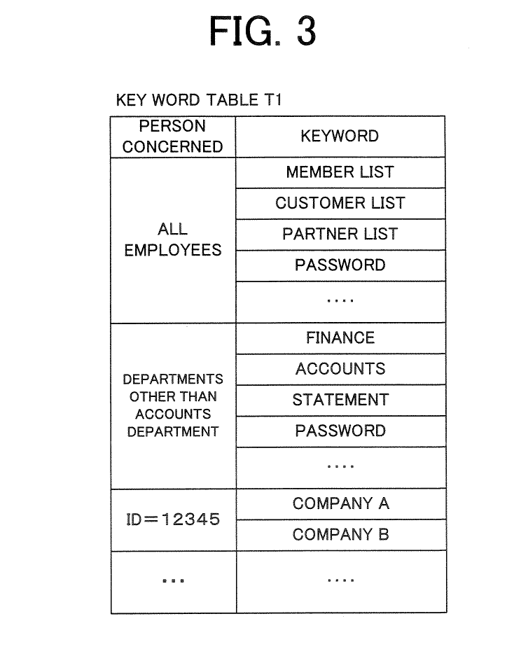

One example of the key word table T1 is shown in FIG. 3. As illustrated in the drawing, the key word table T1 stores keywords, in the unit of business segment or in the unit of employee ID. The keywords are selected from terms, single words and phrases that are less likely to appear in document printed in ordinary businesses, but are likely to appear upon illicit printing.

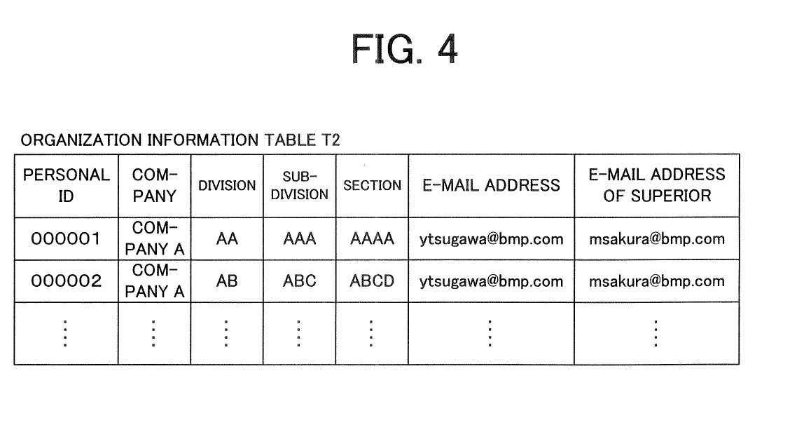

Further, for determining the attribute of the person (for example, the section to which the person is assigned, etc.) who is executing the printing, the storage unit 162 stores the organization information table T2 shown in FIG. 4. The organization information table T2 is prepared for all people who are permitted to use the print server 16. In this organization information table T2, organizations to which individual employees belong and e-mail addresses of the individual employees are stored separately for individual employee IDs. Further, an e-mail address of a superior to which, when a document that includes any keyword registered in the key word table T1 of FIG. 3 is printed, an e-mail for reporting is sent is also stored.

The log display function 212 reads out a print log stored in the log server 17 and displays it on the display unit 163. The items to be displayed are a job ID, a job name, a client terminal name, a user name, a job reception date, a print image, and the like. Among these items, the print image is displayed after the RAW data, which is an image data generated from the print data, is converted into a compression format, such as JPEG (Joint Photographic Experts Group) format and TIFF (Tagged Image File Format) format. Further, in the case where there are a plurality of print logs, a thumbnail is generated from each of the print data and displayed.

The re-printing function 213 is a function of re-printing print data accumulated in the log server 17 as log information.

The browser function 214 displays a print log and a print image on the display unit 163.

The storage unit 162 serves as a memory for spooling, as well as serving as a work area of the control unit 161. Further, the storage unit 162 stores the above-described key word table T1 and organization information table T2.

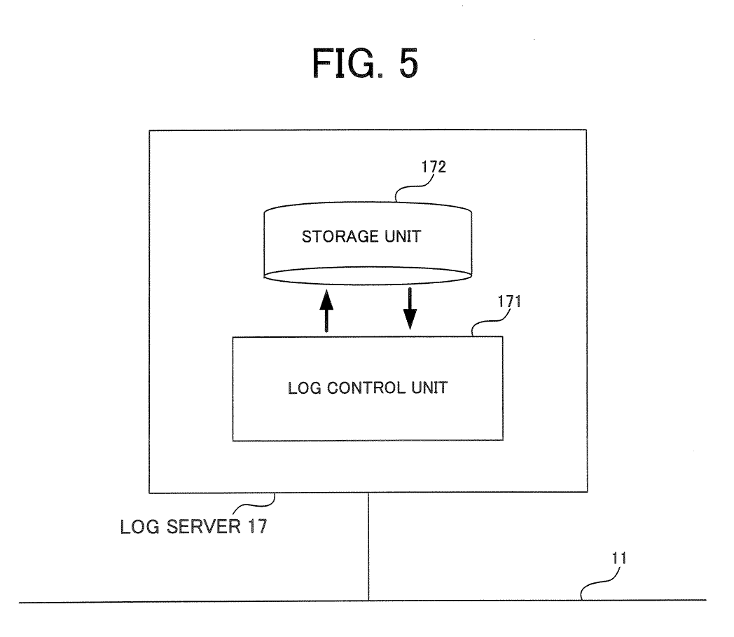

The log server 17 comprises a log control unit 171 and a storage unit 172, as shown in FIG. 5. The log server 17 stores a print log supplied from the print server 16. It also retrieves a stored print log and supplies the log in accordance with a request from the print server 16.

The management terminal 18 is a terminal device for fetching log information (print data and print log) and for retrieving and browsing the print information. The management terminal 18 is constituted by a common personal computer or the like.

Next, an explanation is given of the operation of the printing system having the above-described structure. The explanation begins with an example case, in which print data issued by the client terminal 14 is printed by the printer 12.

The client terminal 14 performs a process of authentication by having a user enter a user ID and a password, and specifies the user, at a time of activation of an apparatus or an application, or a time of printing.

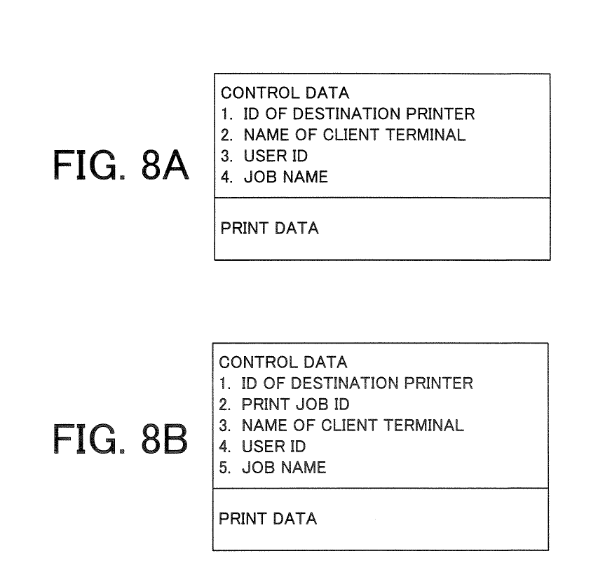

When an instruction of printing is given by an application, the client terminal 14 attaches control data to print data as shown in FIG. 8A, and issues the data to the print server 16. The control data includes the ID of a printer to be the destination of the print job, the name of the client terminal, the user ID and the name of a job, the ID of the printer here designating the printer 12.

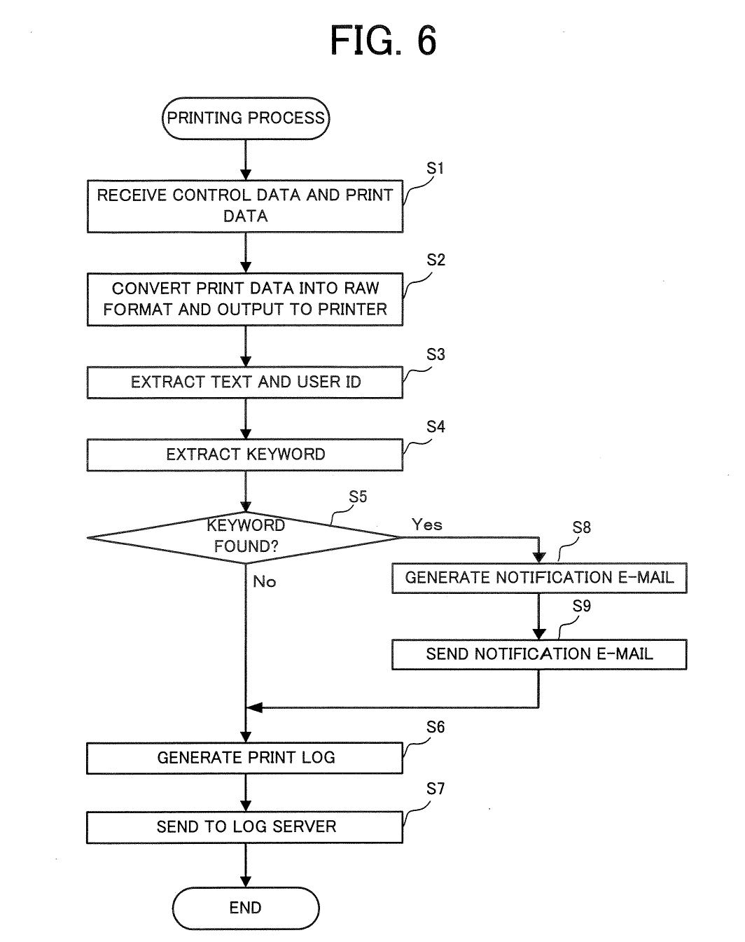

The print server function 211 of the control unit 161 of the print server 16 starts the printing process shown in FIG. 6 in response to a print request from the client terminal 14. First, the print server function 211 receives the control data and the print data (step S1).

Next, the print server function 211 converts the print data into, for example, RAW format. Then, the print server function 211 sends the print data to the printer 12 that is designated as the destination of the print job by the client terminal 14 (step S2). The printer 12 receives the print data sent from the print server 16 and prints it.

Next, the print server function 211 extracts text data from the received print data and specifies the user ID (step S3).

Then, the print server function 211 refers to the key word table T1 and specifies any keyword that is associated with the user ID (step S4).

In this case, the print server function 211 specifies any keyword directly associated with the user ID and any keyword associated with all the users. In addition to this, the print server function 211 refers to the organization information table T2 and determines an organization (a department, etc.) to which the employee specified by the user ID belongs and also specifies any keyword assigned to the organization. For example, if a person of user ID=00001 belongs to an accounts department, the print server function 211 extracts any keyword assigned to the user of user ID=00001 and any keyword set for all the employees in the key word table T1, and any keyword assigned to the accounts department.

Subsequently, the print server function 211 determines whether the text extracted in step S3 includes the keyword extracted in step S4 (step S5).

If no extracted keyword is included (step S5; No), the print server function 211 adds a print job ID and the year, month, date, hour, minute and second of the reception to the print data of RAW data format and the control data, which are sent to the printer 12. Next, as shown in FIG. 8B, the print server function 211 generates a print log including the control data and the print data (step S6). Subsequently, the print server function 211 sends the generated print log to the log server 17 (step S7). The print log server 17 stores and accumulates the generated print log in the storage unit 172.

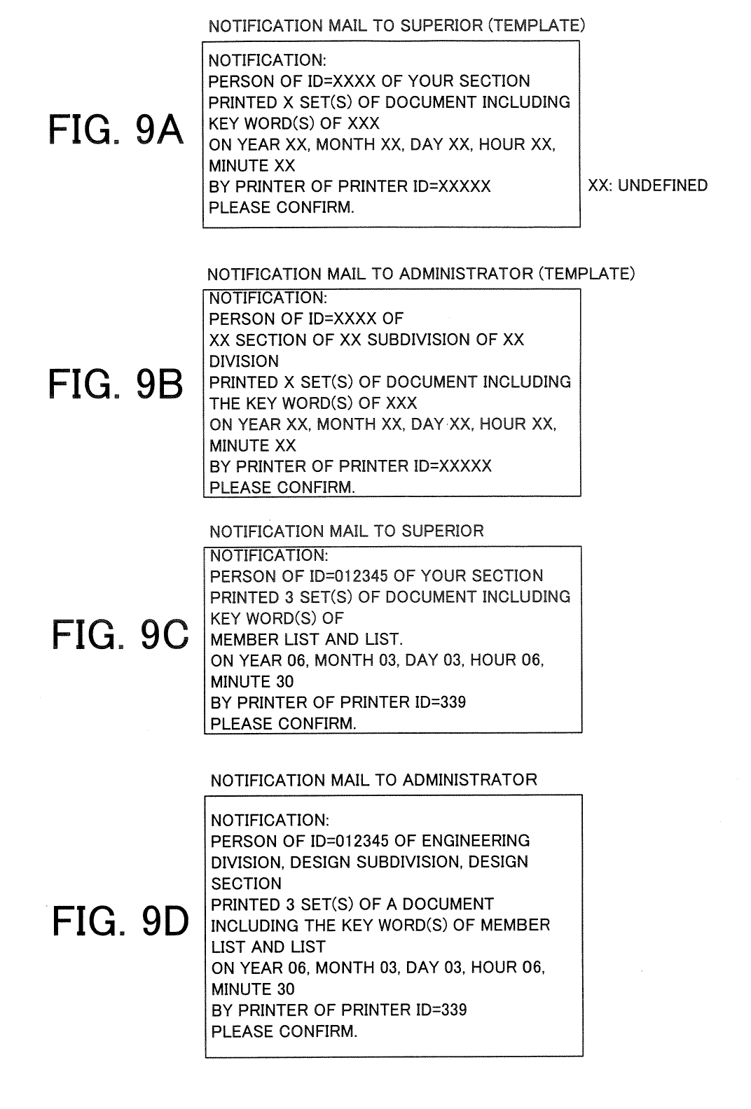

On the other hand, when determining in step S5 that at least one keyword extracted in step S4 is included in the text extracted in step S3 (step S5; Yes), the print server function 211 generates an e-mail for notification (warning) to a superior and an administrator (step S8). This notification e-mail is one in which the user ID, one or more keywords that were determined to be included in the text, and the date and time are inserted into such a template as shown in FIGS. 9A and 9B, as illustrated in FIGS. 9C and 9D. The notification e-mail includes the information that specifies the person who executed the printing, any keyword included in the print data, the time and date and the information that specifies the printer. The control unit 161 sends the generated notification e-mail to the e-mail address of the predesignated system administrator and the e-mail address of the superior with which the user ID is associated in the organization information table T2 (step S9). The process then proceeds to the above-described step S6.

By receiving the e-mail, the superior of the person who executed the printing or the administrator can be aware of the fact that an illicit or potentially illicit printing has been executed.

In this way, when any printing is executed, the log thereof is stored in the log server 17. Further, when such an illicit or potentially illicit printing is executed, an e-mail that notifies that such printing is executed is sent to the superior or the administrator.

Here is described a case in which the superior or the administrator investigates the background of when, how, by whom, etc. the information was printed, upon reception of the notification e-mail sent to them, or a case in which classified information was leaked outside the company and the background of the printing of the information is investigated ex post facto.

In this case, the administrator (or the superior) operates the print server 16 to search through the print log accumulated in the log server 17 and specifies the corresponding print log.

For example, the administrator operates the input unit 164 of the print server 16 and activates the log display function 212 of the control unit 161. Subsequently, the administrator inputs a search command to instruct a search through the print logs. Any item can be used as a search key, for example, employee ID of the person who executed the printing, the range of the time and date of printing, one or more single word(s) or phrase(s) included in the printed document.

The log display function 212 sends the search command and the search key to the log server 17. The log server 17 searches the print logs stored in the storage unit 172 by the use of the supplied search key. Then the log sever 17 extracts a print log that matches the search key and sends it to the print server 16.

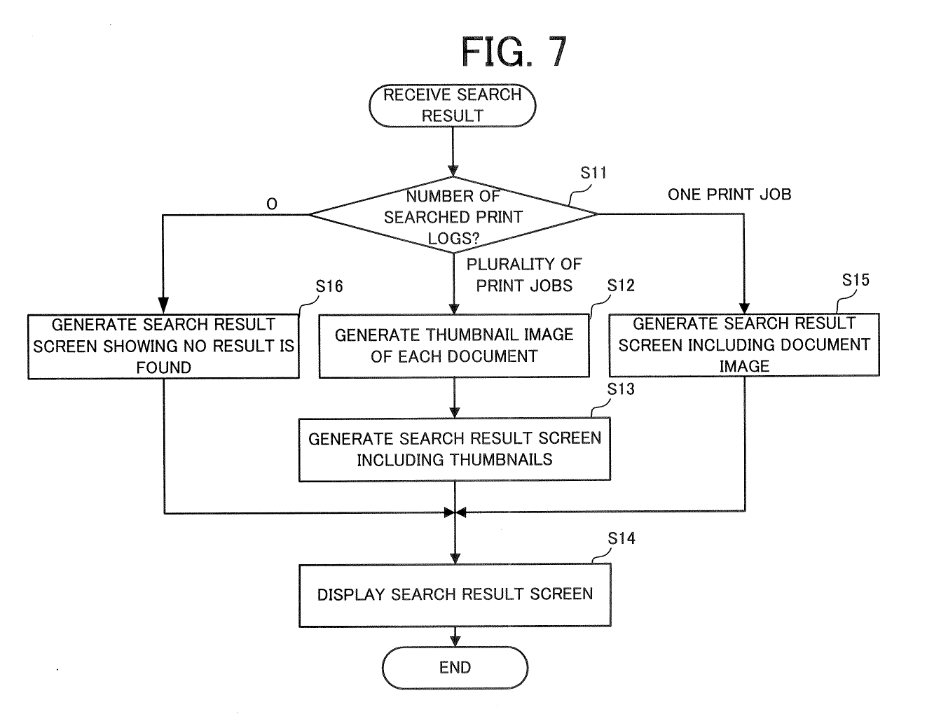

The log display function 212 of the print server 16, when receiving the search result from the log server 17, starts a process shown in FIG. 7.

First, the log display function 212 determines whether plurality of print logs for a plurality of print jobs (printed documents) were found (step S11).

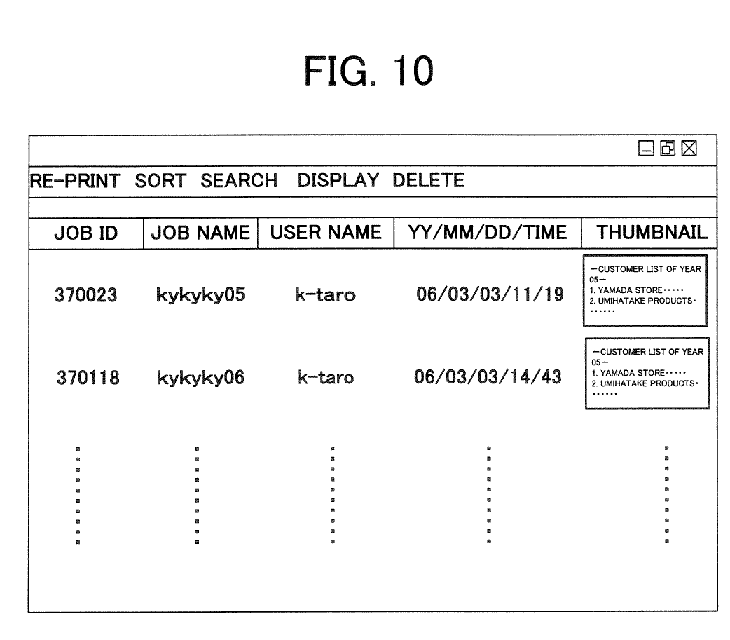

In the case where there are a plurality of the logs for a plurality of print jobs (step S11; plural), the log display function 212 prepares thumbnails (for example, a JPEG image) of the images of the actually printed documents from the print data in the RAW format included in each print log (step S12). Then, the log display function 212 displays a list of the searched print logs in association with the job ID, job name, user name, year, month, day, hour and minute of printing, and thumbnail image, etc. (step S13). FIG. 10 shows an example of a screen of the search result generated by the log display function 212.

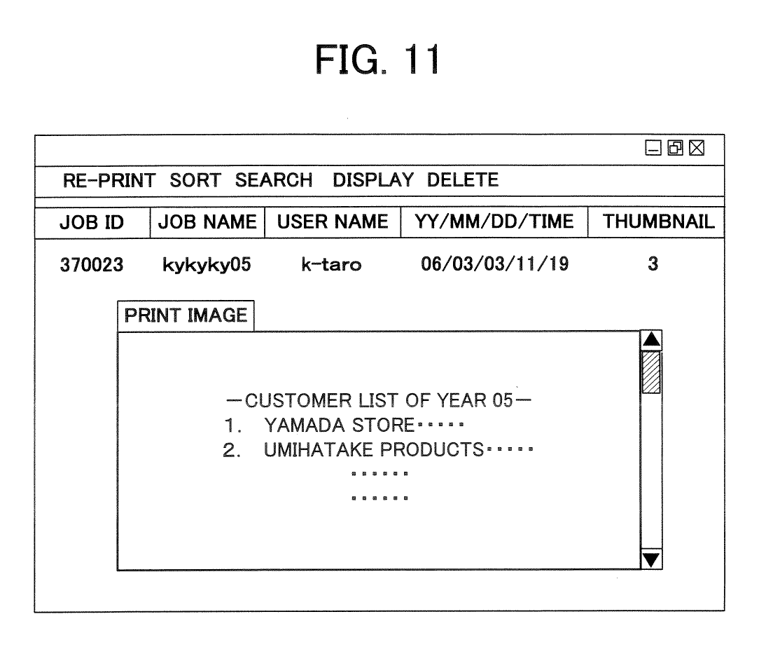

On the other hand, when one print log for one print job (step S11; one) has been found, the log display function 212 generates an image of the printed document (for example, JPEG image) from the print data in RAW format included in the print log, generates a search result screen in which the job ID, the job name, the user name, the year, month, day, hour and minute of the printing, the number of sets of the printed matters are displayed (step S15 and step S14). FIG. 11 shows the search result screen in this case.

Further, in the case where there are no print logs that corresponds to the search key (step S11; 0) the log display function 212 generates a search result screen which notifies that no corresponding print logs exists (step S16) and displays it (step S14).

In the state in which the search result screen of FIG. 10 is displayed, when the administrator designates any of the print jobs from the displayed list and clicks “re-printing”, the re-printing function 213 of the control unit 161 is activated. The re-printing function 213 sends the print data of the designated print job to a predesignated printer and performs printing.

Further, in the screen of FIG. 10, when the administrator designates any of the displayed print jobs and clicks “display”, the log display function 212 is activated. The log display function 212 activates a viewer and converts the designated RAW format document data into, for example, JPEG data, etc., and displays it with the control data, as shown in FIG. 11.

When a new search is necessary and “search” is clicked, the log display function 212 displays, for example, a text box. By the input of any keyword to the text box, for example, a job name and a user name, a search is executed. By this, the control unit 161 requests the log server 17 to search through the print logs in the storage unit 162 and displays a list of any matched jobs, user names and print images, on the display unit 163.

Further, when “sort” is clicked after ascending order or descending order is designated, the log display function 212 sorts the print jobs in accordance with the designated condition.

By clicking “deletion”, it is possible to delete any print data and print log.

In this way, the print server 16 can specify and extract the targeted print data based on the contents of the print logs and enables to check the print data by displaying or printing it. Therefore, according to the printing system of the present embodiment, when information is leaked via printed matters, the person who had printed the matters and the time of printing can be specified. This becomes helpful to specify the person who has leaked the information. Further, by making the function of this printing system known to the members of a company, it is possible to prevent illicit or unnecessary printing. Accordingly, the system helps to prevent the leakage of information.

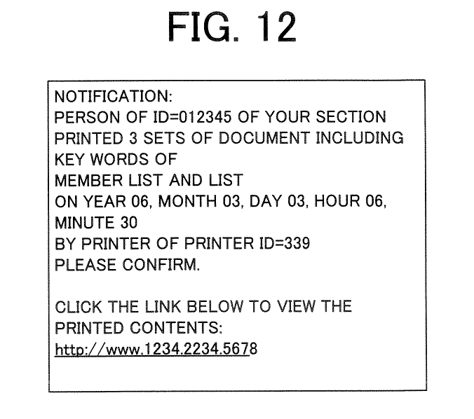

This invention is not limited to the above embodiment and various modifications and application can be made. For example, when a keyword is found, a print image of the document may be generated and a link to the document may be inserted to an e-mail, as shown in FIG. 12. A thumbnail of the print image may be attached to an e-mail and may be pasted thereon.

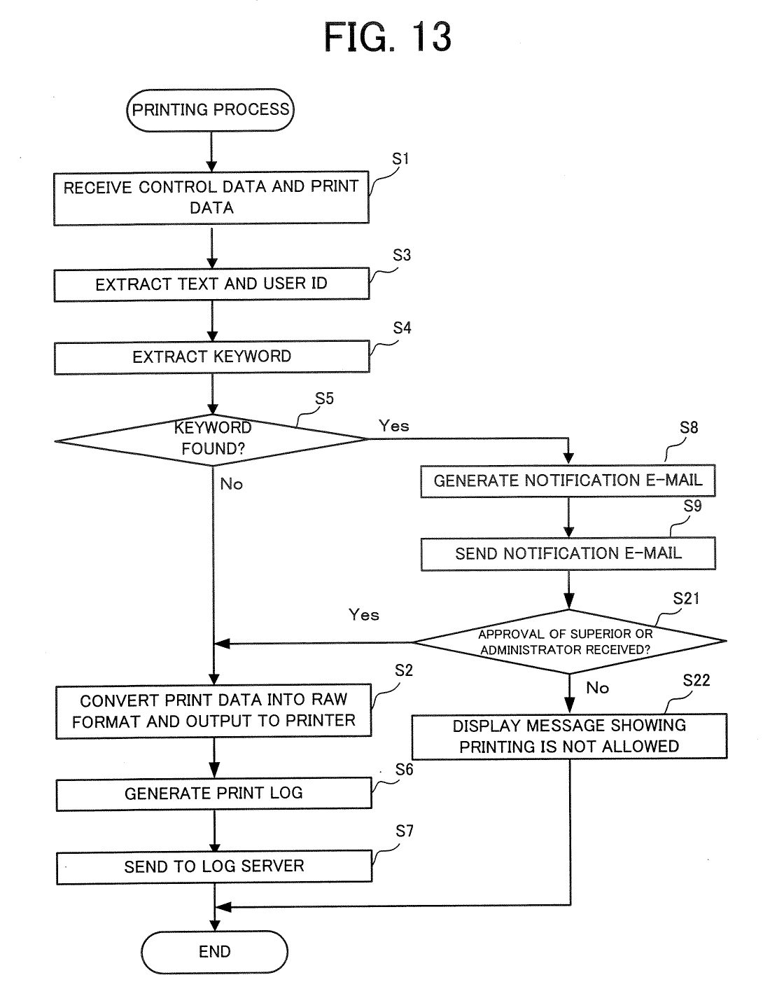

Further, for example, as shown in FIG. 13, step S2 of FIG. 6 may be provided after “No” of step S5, so that printing is inhibited in the case where any keyword is found in the print data.

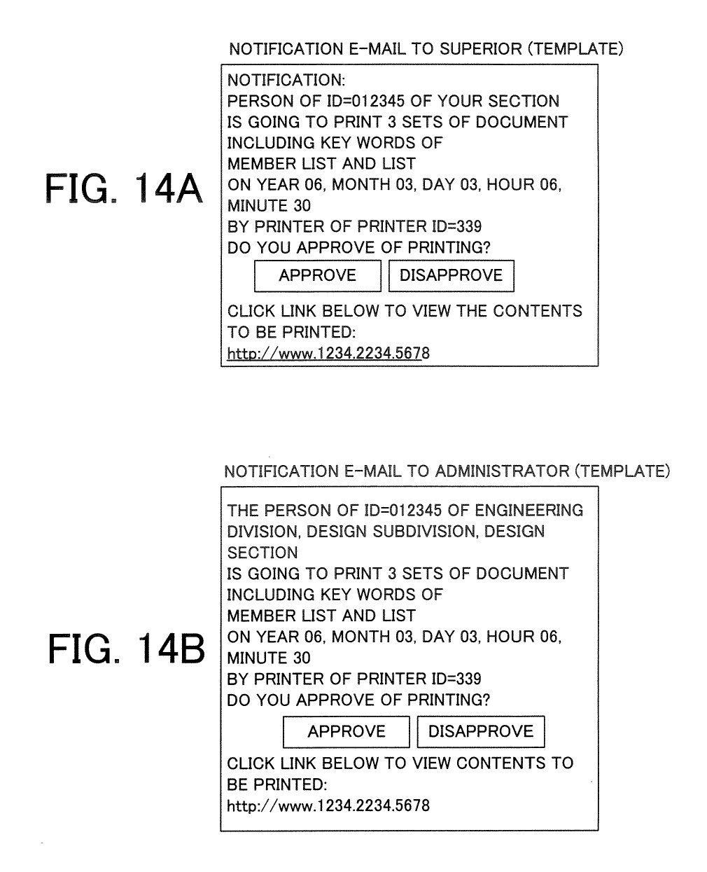

Further, as shown in FIG. 13, when step S5 is Yes (the print data includes a predetermined keyword), a notification e-mail illustrated in FIGS. 14A and 14B may be generated (step S8) and may be sent to a superior and an administrator (step S9). Then, when both (or either one) of them select(s) “approve” button displayed on this e-mail to send the information of approval (step S21; Yes), the process proceeds to step S2 to enable printing. On the other hand, when both (or either one of) them select(s) “disapprove” button to send the information of disapproval (step S21; No), the process proceeds to step S22. When “disapprove” is selected, a message notifying that printing is inhibited may be displayed and the printing process may be terminated.

The destination of the notification e-mail is not limited to the superior and the administrator. For example, individual destinations for the individual keywords may be separately set.

Further, it is possible to include other information in the print log. For example, information showing the result of printing (for example, occurrence of jamming and the page number thereof) or the like, which is returned from the printer after the sending of the printing data to the printer may be recorded.

Further, the format of the print image data generated from the print data is not only limited to JPEG format. GIF (Graphics Interchange format) format and PDF (Portable Document Format) format can be also used.

In the above embodiment, an example in which the log is checked from the print server 16 is described. However, a program for processing print logs may be installed to the client terminals 14 and 15 of a superior or may be installed to the management terminal 18, so that the log can be browsed and printed from these terminals.

The system of this invention can be realized by a common computer system not by a dedicated system. For example, it is possible to configure a server or the like for executing the above-described processes by installing a program for executing the above-described operation to a computer from a recording medium (a floppy disk, a CD-ROM, etc.) having such program recorded thereon. When the above-described functions are realized, for example, or an OS taking some part or by the cooperation of an OS and an application program, it is possible to store only the portion except that the OS can be stored to the medium.

It is possible to embed the program in a carrier wave and distribute it via a communication network. For example, the program may be posted on a Bulletin Board System (BBS) of a communication network and may be distributed via the network.

Then, it is possible to execute the above-described process by activating the program and running it similarly to other application programs under the control of an OS.

As described above, according to the present invention, by securing the log of a print job, it becomes possible to check the contents thereof at a later date, and thus it becomes possible to restrain illicit printing.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2006-084236 filed on Mar. 24, 2006 and including specification, claims, drawings and summary. The disclosure of the above Japanese Patent Application is incorporated herein by reference in its entirety.

What is claimed is:

1. A security management system achieved by storing a print log, comprising a plurality of print request terminals, a management unit and a printer, wherein
each of said plurality of print request terminals includes a unit which sends print data to said management unit, and
said management unit includes:
a reception unit which receives print data sent from said plurality of print request terminals;
a sending unit which sends the print data received by said reception unit to said printer;
a predetermined word detection unit which determines whether or not the print data includes a predetermined word;
an e-mail sending unit which sends, to a previously registered destination, an e-mail that reports that print data including the predetermined word is printed, when said predetermined word detection unit determines that the predetermined word is included in the print data;
an accumulation unit which accumulates a print log including said print data; and
a print log output unit which outputs a print log accumulated in said accumulation unit.

2. The security management system according to claim 1, wherein
said print log output unit includes:
a unit which searches through print data accumulated in said accumulation unit, and
a unit which generates a thumbnail image of a print image of each print data, when more than one print data match the search condition.

3. The security management system according to claim 1, further comprising a unit which inhibits said sending unit from sending the print data to said printer when said predetermined word detection unit determines that the predetermined word is included.

4. A print log management system comprising:
a reception unit which receives print data from a print request terminal;
a sending unit which sends the print data received by said reception unit to a printer;
a predetermined word detection unit which determines whether said print data includes a predetermined word;
an e-mail sending unit which sends, to a previously registered destination, an e-mail that reports that print data including the predetermined word is printed, when said predetermined word detection unit determines that the predetermined word is included in said print data;
an accumulation unit which accumulates a print log including said print data; and
a print log output unit which outputs a print log accumulated in said accumulation unit.

5. A computer-readable storage medium having a print log management program recorded thereon, said print log management program causing a computer to execute the steps of:
receiving print data from a print request terminal;
sending the received print data to a printer;
determining whether the print data includes a predetermined word;
sending, to a previously registered destination, an e-mail that reports print data including the predetermined word is printed, when it is determined that the predetermined word is included,
accumulating a print log including said print data; and
outputting an accumulated print log.
